(19) United States
(12) Patent Application Publication
(10) Pub. No.: US 2022/0380098 A1
(43) Pub. Date: Dec. 1, 2022

(54) VESSEL CLOSURE SEAL AND VESSEL CLOSURE

(71) Applicant: ACTEGA DS GMBH, Bremen (DE)

(72) Inventor: Dany Mängel, Twistringen (DE)

(21) Appl. No.: 17/775,787

(22) PCT Filed: Mar. 18, 2020
(86) PCT No.: PCT/EP2020/057408

§ 371 Date: May 10, 2022

(30) Foreign Application Priority Data
Dec. 10, 2019 (EP) PCT/EP2019/084454

(51) Int. Cl. B65D 53/02; B65D 53/06; C08L 23/14

(52) U.S. Cl. CPC B65D 53/02; B65D 53/06; C08L 23/14

(57) ABSTRACT

The application relates to a vessel closure seal, in particular for fat-containing filling materials, comprising a polymer compound of which the seal consists essentially or entirely, a) wherein the polymer compound is PVC-free and comprises at least one TPS, and at least two different co-PPs, or at least one co-PP with a Shore A hardness of max. 80, a crystallisation enthalpy of max. 30 J/g and a melting point of at least 155° C., b) and the polymer compound has a Shore A hardness at 70° C. of between 30 and 85 and a Molt Flow Index (5 kg/190° C.) of less than 20 g/10 min.

The invention relates to a PVC-free vessel closure seal, in particular, for fat-containing filling materials, comprising a polymer compound of which the seal consists substantially or entirely.

A major problem with polymer-based vessel closure seals is the migration of sealing components into the filling material. Migration problems arise particularly frequently with grease- or oil-containing filling materials since the migrating substances, such as plasticizers and thinners are often fat-soluble.

Larger vessel closures of the type considered here are, in particular, lug cap closures, which are typically used for the closure of screw-lid glasses for food or beverages. These foods are often fat-containing products, such as sauces, delicatessen, fish in oil, antipasti, spice pastes and the like, whose content of fats or oils increases the risk that fat-soluble components of the packaging material dissolve in the food.

These requirements are also particularly relevant for baby food, which is typically sold in jars with press-on Twist-Off® closures (also referred to here as PT closures or PT caps).

The vessel closures affected here usually have an opening width of at least 28 mm, in particular, at least 35 mm, e.g., 38 mm or more, e.g., 82 mm and above. Lug caps closures can have four, five or more than five lugs.

Conventional PVC-based vessel closures show favourable sealing properties. On the basis of soft PVC technology, it is also possible to formulate sealants with less migration, which often use polyadipates. These are less prone to migration due to their molecular weight.

The prescribed analysis method EN 1186 for the evaluation of the migration postulates that it is completed after 10 days of storage at 40° C. Analytical practice teaches that this is not the case in the case of softened PVC so that even if the test conditions are met, closures cross the migration limits after just a few months.

It is also undesirable to use PVC-containing compounds in packaging materials. In the usual combustion of household waste, acidic gases are produced from halogenated plastics, the escape of which into the atmosphere is harmful. In addition, even small amounts of PVC interfere with the material recycling of plastic waste. In addition, such PVC-based sealing elements require the use of plasticizers, which are also questionable for reasons of unjustifiable change in the food. Furthermore, there has been a public discussion in recent years about additives used in PVC seals and their decomposition products. Examples of this are 2-ethylhexanoic acid, which often comes from stabilizers, and semicarbazide, which can be formed from exothermic expanding agents such as azodicarbonamide. These substances were also found in filling materials during official controls and their presence was objected to.

The migration of components of the packaging (which may also include the sealing insert of the vessel closure where applicable) into the food is not only generally undesirable, but also strictly regulated by legal provisions. Examples of such provisions are EC Regulations 1935/2004, 2023/2006, (EU) 10/2011, including supplements (EU) 321/2011, (EU) 1282/2011, (EU) 1183/2012, (EU) 202/2014, (EU) 174/2015, (EU) 2016/1416, (EU) 2017/752, (EU) 2018/79, (EU) 2018/213, (EU) 2018/831, (EU) 2019/37 and (EU) 2019/1338. Currently, maximum levels of 60 ppm of migrating ingredients are permitted for infant food.

The measurement of the extent of any observed migration where applicable is carried out by means of methods as defined in particular in DIN EN 1186. Such methods are also used in the context of the present invention.

There is therefore a need for PVC-free vessel closure seals that come as close as possible to the favourable properties of the well-known PVC-containing seals.

According to the invention, PVC-free compounds are used. In the product according to the invention, the migration can be largely or completely avoided by the avoidance of liquid components and/or by the use of less migration-prone polymers and other measures.

It is not a trivial problem to provide PVC-free sealing inserts for vessel closures of the type under consideration here if these closures have to comply with the above provisions regarding the possible migration of their chemical components. The sealing function must also be guaranteed under filling conditions.

The requirements for the sealing materials for vessel closures for larger inner diameters (of at least 28 mm, often at least 35 mm) of the vessel opening are more demanding because of the relatively larger amounts of material in the seal. For such purposes, it is particularly important to combine a sufficient flowability of the polymer material in the production of the sealing element with sufficient sealing properties in the sealed state; this also includes the tightness required nowadays against the penetration or escape of gases, combined with a pressure-relief-valve effect where applicable, which prevents the bursting of the vessel during heating or the development of overpressure in the vessel for other reasons. In addition, particularly for the typical applications of vessels with larger opening diameters (for example, canned food), it is required that the sealing element can also be used under pasteurization conditions (at least 98° C.) and possibly even sterilization conditions (above 100° C. up to 132° C.)

With all these characteristics, the seals must also meet the above requirements with regard to the possible migration of chemical components.

The vessel closures should be able to be attached quickly and with minimal evaporation to the container to be closed. In addition to the usual mechanical sealing process, the closures should also be suitable for manual closure.

A solution to these problems, which has in the meantime been successfully introduced, is disclosed in our application EP 09 756 681, now Patent EP 2 470 435. The seal described there is PVC-free and is based on a combination of at least one olefin block copolymer (OBC) with at least one polyolefin elastomer (POE), high density polyethylene (HDPE) or polypropylene or propylene copolymer ((co-)PP). It should not contain any TPS. The Shore A hardness is between 45 and 95, the compression set is between 30% and 90%.

Similar vessel closures are known from WO2012/152329, in which the seal comprises a polymer compound with 35% homo-PP, 44% OBC/TPS and 20% POE.

In order to facilitate the processing of conventional compounds, thinners and/or plasticizers are usually added to them. In particular, liquid components such as expanded oils and/or plasticizers (preferably white oil) are used at application temperature. However, lubricants and liquid components at 20° C. are substantially or preferably entirely dispensed with in the known formulations, as they can promote migration.

The product known from EP 09 756 681 is ideal for many applications but can still be improved for some uses. For example, mechanical sealing processes can lead to severing of the seal if the closing distance is very short and the machine can only be adjusted to a limited extent. In the case of very fast-running machines for pre-evaporated closures, the processing time is sometimes not sufficient for sufficient warming up of the closure.

It would therefore be desirable to have a seal that is thermally stable and softer than the seals known from EP 09 756 681 and that leads to fewer occurrences of being severed. This seal should preferably have the advantageous properties of the known seal.

Seals should also have opening values that are as low as possible so that screw closures such as cam screw closures, PT closures and other screw closures can be easily opened. It must be ensured that the closure is not opened unintentionally, which is why the opening value cannot be too low.

With conventional 82 mm Twist-Off® closures, the opening values of PVC-containing seals are often in the range of 4.8-6.2 Nm (42-55 inch/lbs) and higher. Technically complex Orbit® closures, with PVC-based seals with low migration values, designed to reduce the torques required for opening, are less than 4 Nm. With the well-known seal in accordance with EP 09 756 681, typical opening values for Twist-Off® closures are 4.3-5.1 Nm. A lower opening value would be advantageous for PVC-free closures.

The creation of a seal with the above properties is an essential object of the invention.

In principle, the invention solves these and other problems by means of the feature combinations specified in the independent patent claims.

As with the solution in accordance with EP 09756681, the disclosure of which we fully include by reference in the disclosure of this application, the seal of the invention preferably comprises a polymer compound that is introduced in thermally sufficiently flowable form into a closure blank made of metal or plastic, thereby being stamped or the like into the desired shape, which it retains after cooling. In these cases, the finished seal usually consists entirely of the polymer compound. Machines for corresponding manufacturing processes are, for example, available from SACMI.

The terms “seal”, “seal insert” and “sealing element” are synonymous in the context of this description.

In the case of the vessel closures according to the invention, the sealing element is similarly formed as an insert on the inner surface of the vessel closure, as is also the case with the known crown caps or screw closures.

In principle, in accordance with the manufacturing method according to the invention, a vessel closure blank made of metal is assumed, which is preferably first pre-treated on its inner side with a suitable primer. In the case of a plastic vessel closure, this pre-treatment is not necessary.

Usually, the coating system of this primer consists of a base coat and an adhesive varnish, both of which can be based on an epoxy phenolic resin system or (usually for regulatory reasons) on polyesters. In particular, coating systems of the company ACTEGA Rhenania (base paint TPE279 with adhesive varnish TPE 1500 or ACTEcoat® TPE 515 with ACTEbond® TPE-655-MF), on which the most preferred compounds according to the invention adhere particularly well.

Alternatively, a suitable primer coating can be applied by means of lamination or also possibly by co-extrusion.

On the pre-treated blank is applied in preferred embodiments on the inside of the polymer material in a thermally flowable form to form the seal. In particular, an extrusion is suitable for this, in which the sealing compound is presented at a temperature range between 100° C. and 260° C.

The extrusion can take place approximately in the middle of the blank inner surface if the sealing insert is to be circular disc-shaped. The dosage of the polymer material for extrusion is carried out by stripping a defined amount of the polymer compound on a nozzle.

While, in the case of known bottle closures (crown caps and the like), the sealing element is usually formed as a circular disc on the inner side of the vessel closure, it can be favourable in the case of larger vessel closures like according to the invention to instead form only a ring of polymer material, which lies on the vessel wall in the opening area in the closed state of the vessel.

For this purpose, the method described in U.S. Pat. No. 5,763,004 can be used, which is included by reference in the present description.

Subsequently, the circular disc-shaped sealing element is preferably formed from the extruded, still flowable material by appropriate stamping (analogous to the well-known SACMI method).

In a modified form, the sealing element can be formed outside the closure or closure blank by stamping a suitable polymer material and then inserted into the closure or blank. This method is also known by SACMI as outshell-moulding.

As the main component or single component, the material of the sealing insert comprises a PVC-free polymeric component (i.e., a polymer compound), which in one variant comprises at least three different polymers, namely at least one TPS and a first co-PP and a second co-PP different from the first co-PP at least in a physical and/or chemical parameter. In a second variant, the component comprises at least one TPS and at least one co-PP, wherein this co-PP has a Shore A hardness of a maximum of 80, a crystallization enthalpy of a maximum of 30 J/g and an MFI of less than 20 g/10 min.

The properties of this main polymeric component can be suitably modified by the addition of further components, for example further polymers.

The invention thus detaches itself from the concept known from EP 09 756 681, according to which the desired seal or the polymer compound of the seal must contain an OBC. An OBC can but does not have to be contained in the seal according to the invention.

Furthermore, the invention detaches itself from the concept in accordance with EP 09 756 681, according to which the seal or the seal compound may not contain a TPS.

The invention is instead based on the knowledge that thermally and mechanically stable, but softer generic seals can be obtained if the polymer compound comprises certain types of TPS, in particular, SEBS in combination with certain types of co-PP. Not all known types of TPS and not all known types of co-PP are suitable for this, as will be described below.

It is preferably provided that the material of the sealing insert has only very low and particularly preferably no contents of components that are liquid at application temperature. The application temperature is usually equal to the ambient temperature, i.e., within the range of usual ambient temperatures outdoors or in heated rooms. Typically, the application temperature is 20° C.

Preferably, therefore, only small or preferably no contents of liquid thinners such as in particular white oil are added to the material of the sealing insert.

Preferably, the material does not contain more than 10%, preferably not more than 7%, in particular, not more than 5% of lubricants—in particular, those which pass into the fat-containing filling material in a limited manner during a migration test at 40° C. for 10 days (percentages are always weight percentages in this application based on the total weight of the compound in the seal unless expressly stated otherwise).

It is currently most preferred that the material contains no liquid constituents at 20° C. and also no usual plasticizers within the analytical limits of determination given in the prior art at the time of application.

Polymer compounds according to the invention generally have a Shore A hardness between 30 and 85 at 70° C., more specifically a Shore A hardness between 40 and 75. The lower the hardness, the easier it is to attach the closures. When used on steam-vacuum capping machines, there is an increased risk of severing if the hardness is below Shore A 30. Above Shore A 85, there is an increased risk that sealing will not be successful. When used on cold vacuum sealing machines without preheating, no vacuum is achieved at a Shore A hardness above 85.

The polymer compound preferably has a high viscosity, i.e., MFI (5 kg/190° C.) in accordance with DIN EN ISO 1133 of less than 20 g/10 min., more preferably, less than 15 g/10 min, even more preferably of less than 10 g/10 min, and particularly preferred less than 6 g/10 min. Particularly for processing on cold vacuum sealing machines, it can be useful to set other viscosities.

The compression set of the polymer compound in accordance with DIN ISO 815-1, type B, method A, isotropic test specimens, is:
At 4° C., between 5% and 45%, particularly between 10% and 40%, preferably between 15% and 30%;
at 23° C., between 15% and 55%, particularly between 20% and 50%, preferably between 25% and 40%;
at 70° C., between 35% and 85%, particularly between 50% and 80%, preferably between 55% and 70%.

A valuable method for characterizing the mechanical properties of elastic polymer materials is the anisothermal stress relaxation test (AISR method). According to VENNEMANN (e.g., in the essay “PRAXISGERECHTE PRÜFUNG VON TPE” (Translation for understanding the subject matter: “PRACTICE-ORIENTATED TESTING OF TPE”), thermal application limits for TPEs can be determined with this method. As an essential parameter, the limit temperature is determined from the test at which 90% of the stress initially applied by a stretching an S2 test specimen at room temperature is reduced by 50% (T90). The higher the determined limit temperature T90, the greater the thermal stability of the tested material.

The “TSSR meter” from Brabender Messtechnik is suitable for carrying out the measuring method. This method serves as a substitute or supplement to the known (and standardized) determination of the compression set and provides data that correlate with the elasticity of the polymer material.

The T90 value shows from which temperature the voltage decreases by 90%, i.e., at a certain temperature, the sealant or compound has only 10% voltage. Experience has shown that all compounds according to the invention are at T90 values of at least 80° C. By means of the T90 values it can be read out whether there is no severing during the sealing process with the steam-vacuum sealing machine with a low Shore A hardness less than 40 at 70° C. or TSSR initial forces at 10N and T90 at 80° C.

In addition, the force required to generate 50% voltage at 23° C. can be read. Surprisingly, we have found that with forces smaller than 10 N there is often a risk of severing (steam-vacuum capping machine), while forces greater than 40 N often cause sealing problems with both commercially available steam as well as cold vacuum sealing machines. These are mainly indicated by vacuum loss directly after the sealing process and thus lead to rejects during production.

This problem applies to all steam-vacuum capping machines and cold vacuum sealing machines commonly used on the day of registration, e.g., Arol Geyser, Tecnocap TSM 500, Unimac Gherri GG400, Pano DVV 100 E EL, Silgan White Closure 300 and Crown Global Capper.

The preferred range of this force for polymer compounds according to the invention is between 15 N and 25 N (strain 50% j23° C.) for the steam-vacuum sealing machine, and at 5 N and 15 N for the cold vacuum sealing machine.

After sealing, during and after the cooling process and often also during the storage of the sealed container, PVC-free compounds lead to crystallization processes in the polymer compound. These influence the hardness and elasticity of the seal, and thus the tension between the closure and the container during cooling after the sealing process. The slower the crystallization takes place, the smaller the build-up voltage, which negatively affects the opening torque.

The peak crystallization temperature and the total enthalpy of crystallization related to the weight is determined by DSC measurement (dynamic scanning calorimetry) from the first cooling curve. The rules for this are described in the ISO 11357 standard or its subchapters (in particular 15011357-3). The quantities were measured using a DSC1 system from Mettler Toledo.

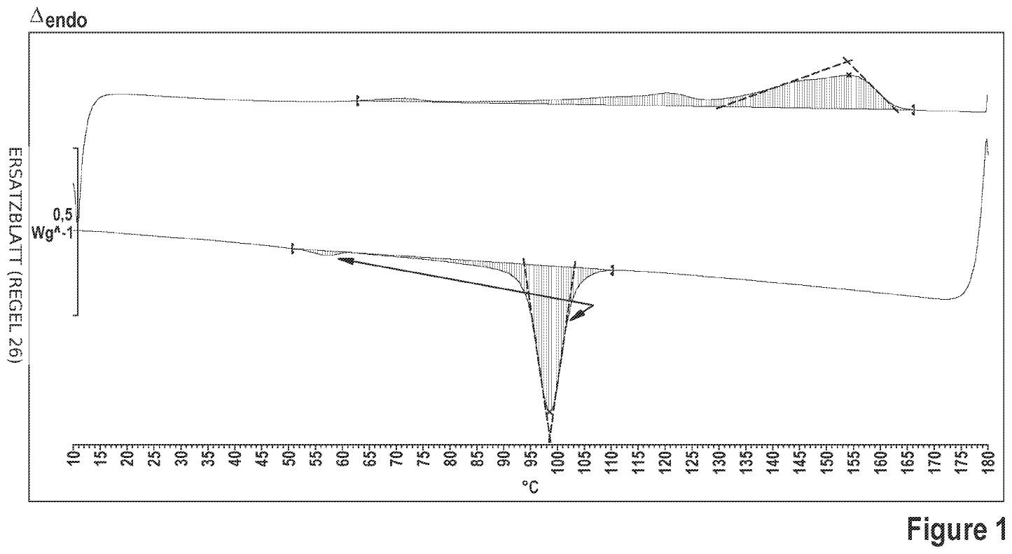

FIG. 1 shows an example of such a DSC curve.

It has proven helpful in describing the suitability of a sealing material for vacuum screw closures to design polymer compounds in such a way that the temperature of the exothermic peak is higher than the expected maximum operating temperature of the vessel closure. This exothermic peak temperature from the crystallization process is partly well below the temperature of the endothermic melt peak.

Basically, the invention prefers the use of such polymers having low degrees of crystallinity, while particularly crystalline polymers such as homo-PP, LLDPE, LDPE and HDPE are preferably not used at all or only to a reduced extent.

Preferred polymer compounds have a specific total crystallization enthalpy above room temperature of less than 45 J/g, more preferably a maximum of 38 J/g, more preferably a maximum of 30 J/g.

The TPS used according to the invention are preferably SEBS and/or SEEPS. In addition or as an alternative, at least one polybutene can be used.

In general, linear SEBS and/or SEEPS with styrene content levels between 26% and 34% are preferred. Particularly preferred are SEBS and/or SEEPS with styrene content levels between 29% and 33%, and usually preferred are SEBS and/or SEEPS with 31% to 32% styrene.

Preferred polymer compounds generally comprise up to 50%, more specifically up to 45%, more preferably up to 40% TPS. Preferably, such polymer compounds comprise at least 10%, specifically at least 20% and more preferably at least 30% TPS.

TPS are not in themselves particularly suitable polymers for sealing compounds that come into contact with fat-containing or oily fillers because they facilitate the entry of greases and oils into the seal. This is particularly true for products that are thermally treated, e.g., pasteurized or sterilized.

In accordance with EP 09 756 681, it is necessary to dispense with TPS contents in the polymer compound to the furthest extent possible.

However, it has surprisingly turned out that TPS can also be successfully used in sealing compounds for applications in greases and oils if the polymer compound contains certain polypropylene copolymers (co-PP). Apparently, the co-PP content prevents the absorption of fats and oils through the seal even in the presence of TPS and also in pasteurization and even sterilization (up to temperatures of 132° C.) Homo PPs are not used in favoured embodiments of the invention in place of co-PPs.

In preferred embodiments of the invention, the TPS portion of the polymer compound consists of at least two different TPS, in particular two different SEBS.

As the main component of this TPS content preferably linear SEBS serves a, which has a Shore A hardness of 50 to 90, preferably from 55 to 80 and as a 5% by weight solution in toluene has a dynamic viscosity of>50 mPa·s (measured at 25° C.) and as a 10% by weight solution in toluene has a dynamic viscosity of>1000 mPa·s.

Particularly preferred SEBS for this proportion are linear triblock copolymers of type S-E/B-S.

Products such as KRATON® G1651 and CALPRENE® 6174 are particularly suitable.

As a modifier then preferably serves a second SEBS with a styrene content of between 10% and 23%, a Shore A hardness between 30 and 60 and an MFI (2.16 kg/230° C.) between 2 and 30 g/10 min.

KRATON® G1645 or G1643 can be used in a mixture with KRATON® G1651 to increase the flexibility of the compound (in the sense of a plasticiser, instead of white oil).

The polymer compound further has a content of at least one co-PP.

The invention preferably uses contents of one or a plurality of co-PPs instead of contents of homo-PP in the polymer compound.

In a first variant of the invention, the polymer compound contains two different co-PPs.

The first co-PP preferably has a Shore D hardness below 25, more preferably below 20.

It preferably has a DSC melting point of above 145° C., more preferably above 155° C. The melting point of the first co-PP is preferably higher than that of the second co-PP.

The first co-PP preferably has a total enthalpy of crystallization of less than 30, more preferably less than 25 and usually preferably less than 20 J/g.

The MFI (2.16 g/10 min.) of the first co-PP is preferably below 30, more preferably below 20 and usually preferably below 10 g/10 min.

The second co-PP preferably has a Shore D hardness above 25, more preferably above 30, but below 45.

It preferably has a DSC melting point of above 140° C., more preferably above 145° C.

The second co-PP preferably has a total enthalpy of crystallization of less than 40, more preferably less than 35 J/g.

The MFI (2.16 g/10 min.) of the second co-PP is preferably below 35, more preferably below 25, and usually, preferably below 10 g/10 min.

The total amount of co-PP used in the compound is preferably generally 20%-65. The content level of the first co-PP is preferably greater than the content level of the second co-PP.

Particularly suitable products are the ADFLEX grades C290F and Q190F from LyondellBasell, DuClear QT80A from Ducor and TAFMER PN 3560 from Mitsui Chemicals.

In preferred embodiments of the invention, the co-PP can be partially replaced by other polymers, for example by LLDPE.

In a second variant of the invention, the polymer compound contains at least one co-PP with a Shore A hardness of max. 80, a crystallization enthalpy of max. 30 J/g and a melting point of at least 155° C.

Also in this second variant, the polymer material may contain another polymer, e.g., another co-PP or polyolefin.

As a further component of the polymer compound, the invention uses contents of at least one POE in certain embodiments.

Preferred POE contain PP units and randomly copolymerised ethylene units.

The content of POE is preferably between 10% and 50%, more preferably between 20% and 40%. VistaMAXX grades from ExxonMobil, e.g., VISTAMAXX 6202, are particularly suitable.

The polymer materials can withstand a hot filling of up to 100° C. for up to 60 min, starting from a hot filling of at least 60° C. in a maximum of 10 min and at least 1 min. The hot filling, starting from 60° C., can be carried out in steps from 5° up to 100° C. in 60 min.

Optionally, pigments, preferably inorganic pigments, can also be added to the formulations of the compounds to exclude pigment migration. It has also been shown that other additives such as waxes, silicones and in particular expanding agents can be added to the polymer compounds in order to improve, for example, the processing and the performance properties.

In the following, exemplary embodiments of the invention are described on the basis of the composition of the polymer compounds from which the vessel closure seal according to the invention was formed as stated above:

Exemplary Embodiment 1:

15% first co-PP

14% second co-PP

33.4% SEBS 35% POE

2.6% lubricants and additives

Exemplary Embodiment 2:

20% first co-PP

14% second co-PP

33.4% SEBS

30% POE

2.6% lubricants and additives

1. Vessel closure seal, in particular for fat-containing filling materials, comprising a polymer compound of which the seal consists substantially or entirely,
a) wherein the polymer compound is PVC-free and comprises at least one TPS, and at least two different co-PPs, or at least one co-PP with a Shore A hardness of max. 80, a crystallization enthalpy of max. 30 J/g and a melting point of at least 155° C.,
b) and the polymer compound has a Shore A hardness between 30 and 85 at 70° C. and a melt flow index (5 kg/190° C.) of less than 20 g/10 min.

2. Vessel closure seal according to claim 1, in which the at least one co-PP has a Shore A hardness of max. 75 and/or a crystallization enthalpy of max. 20 J/g and/or a melting point of at least 160° C.

3. Vessel closure seal according to claim 1, in which the polymer compound substantially does not comprise homo-PP.

4. Vessel closure seal according to claim 1, in which the polymer compound comprises at least one of SEBS, SEEPS or Polybutene.

5. Vessel closure seal according to claim 1, in which the polymer compound comprises a linear SEBS or SEEPS with a styrene content level between 26% and 34% styrene.

6. Vessel closure seal according to claim 1, in which the polymer compound comprises at least 20% TPS.

7. Vessel closure seal according to claim 1, in which the polymer compound contains a linear SEBS having a Shore A hardness of 50 to 90 and a 5% by weight solution in toluene has a dynamic viscosity of>50 mPa·s (measured at 25° C.) and as a 10% by weight solution in toluene has a dynamic viscosity of>1000 mPa·s.

8. Vessel closure seal according to claim 1, in which the polymer compound has a second SEBS with a styrene content of between 10% and 23%, a Shore A hardness between 30 and 60 and an MFI (2.16 kg/230° C.) between 2 and 30 g/10 min.

9. Vessel closure seal according to claim 1, in which the polymer compound comprises a first co-PP with a Shore D hardness below 25.

10. Vessel closure seal according to claim 1, in which the polymer compound comprises a first co-PP with an MFI (2.16 g/10 min.) of the first co-PP of below 30 g/10 min.

11. Vessel closure seal according to claim 1, in which the polymer compound comprises at least one co-PP with MFI (2.16 kg/230° C.) of at least 0.1 g/10 min.

12. Vessel closure seal according to claim 1, in which the DSC melting point of the first co-PP is higher than that of the second co-PP.

13. Vessel closure seal according to claim 1, in which the polymer compound comprises a first co-PP with a DSC melting point above 145° C.

14. Vessel closure seal according to claim 1, in which the polymer compound comprises between 20% and 70% co-PP.

15. Vessel closure seal according to claim 1, in which the polymer compound comprises at least one POE.

16. Vessel closure seal according to claim 15, in which the content of POE is between 10% and 50%.

17. Vessel closure seal according to claim 1, in which the polymer compound does not contain more than 10% of lubricants.

18. Vessel closure seal according to claim 1, in which the polymer compound does not contain more than 10% of liquid components at 20° C.

19. Vessel closure seal according to claim 1, which can be pasteurized at temperatures above 98° C.

20. Vessel closure, in particular vacuum vessel closure, made of metal or plastic, with a vessel closure seal according to claim 1.

21. Vessel closure according to claim 20, having a diameter of at least 28 mm.
